(19) United States
(12) Patent Application Publication
(10) Pub. No.: US 2015/0240524 A1
(43) Pub. Date: Aug. 27, 2015

(54) CREDIT CARD-SIZED SLIM TOOL SET

(71) Applicant: Craig Olroyd, Santa Barbara, CA (US)

(72) Inventor: Craig Olroyd, Santa Barbara, CA (US)

(21) Appl. No.: 14/631,640

(22) Filed: Feb. 25, 2015

Related U.S. Application Data
(60) Provisional application No. 61/944,768, filed on Feb. 26, 2014.

(51) Int. Cl. E05B 19/20; B25B 33/00; B25H 3/02

(52) U.S. Cl. CPC E05B 19/20; B25H 3/02; B25B 33/00

(57) ABSTRACT

A slim tool set including a card case and a plurality of tools retained therein. The card case may be credit card-sized, and one useful application is for a plurality of lock picking tools. The card case includes a plurality of slots for receiving the tools formed by removing material from the opposite faces of the card case. Each slot is formed by a plurality of recesses formed in the opposite faces that overlap to connect the recesses and form the slot which extends from end to end of the card case. Each of the slots has a thickness dimension slightly smaller than the thickness dimension of the tools such that the tools are retained by friction therein.

### RELATED APPLICATIONS

The present application claims priority under 35 USC §119 to U.S. Provisional Ser. No. 61/944,768, filed Feb. 26, 2014.

### FIELD OF THE INVENTION

The present invention is directed to a slim tool set and, in particular, to a credit card-sized lock-pick set.

### BACKGROUND OF THE INVENTION

One of the more popular types of mechanical locks is referred to as the pin-tumbler lock or pin-tumbler cylinder lock. Pin-tumbler cylinders are used in a great variety of locks including padlocks, door locks, automobile vehicle locks, and in specialty locks. This type of lock is well known and widely used. Generally, the lock comprises a cylinder which receives a plug the rotation of which opens or closes the lock. The plug carries a plurality of pins that are slidably received in lateral passages. The pins are spring biased to the closed position. The pins are of different lengths and, therefore, align with the open position only when the proper key is inserted. When the proper key is inserted, the pins are positioned so that they do not extend into the cylinder nor do pins mounted in the cylinder extend into the plug. In this position, and only in this position, do the pins permit rotation of the plug and, consequently, the opening of the lock.

Lock picks are also well known. Lock picks come in a variety of sizes and shapes and are useful for different kinds of locks. One of the more common kinds of lock picks is used for the pin-tumbler type of lock. One type of lock pick for the pin-tumbler type of lock uses a small flat tool with one or more projections thereon and a tension tool. As the tension tool is used to turn the plug, or exert a turning force on the plug, the pick is inserted into the lock and moved forwardly and backwardly along the plug pushing the pins up. By careful manipulation, the pins will align themselves to the open position and the tension will keep them in the open position until all of them are aligned and the lock opens. It is to this type of lock pick that the present invention is directed.

In operational concept these lock picks have been known for a very long time and are known in a variety of sizes and shapes. Certain lock pick sets that are ostensibly credit-card sized are available. However, these devices are invariably made of cheap materials, and are quite a bit thicker than a credit card. See, for example, the Credit Card Lock Pick Set available on the internet from, among many websites, lockpickshop.com (http://www.lockpickshop.com/CC-LOCK-PICK-SET.html). This set is ⅛ inches (3.175 mm) thick, while a standard credit card has a thickness of 0.030 inches (0.762 mm), or 0.050 including the embossed numbering. Moreover, the tools are made of stamped stainless steel which is of low quality for the purpose, and will invariably deform and become dysfunctional after several uses.

Thus, there is a need for a quality slim lock pick assembly that is configured to be carried in a wallet or shirt pocket and that comprises all of the elements necessary to open a pin-tumbler type of lock, and other locks that are similarly opened.

### SUMMARY OF THE INVENTION

The present invention comprises an assembly of a tool card and a number of tools which is easily carried in the wallet or shirt pocket of the locksmith and can be used quickly and efficiently. Those who have need to work on locks regularly, maintenance personnel, etc., will also find the configuration of the slim lock pick assembly of this invention to be a great convenience. The principles disclosed herein are also applicable to other toolsets than those for picking locks. For example, many of the tools that are contained in a Swiss-Army knife are suitable for storing in the tool card described herein.

A further understanding of the nature and advantages of the invention will become apparent by reference to the remaining portions of the specification and drawings.

### BRIEF DESCRIPTION OF THE DRAWINGS

Features and advantages of the present invention will become appreciated as the same become better understood with reference to the specification, claims, and appended drawings wherein:

FIG. 1 is a perspective view of the slim tool set of the present application;

FIG. 2 is an exploded plan view of the slim tool set of FIG. 1, showing a card case and four lock picking tools that are retained therein;

FIG. 3 is a perspective view of the card case of FIG. 2 with the lock picking tools removed;

FIGS. 4A-4D are various orthogonal views of the card case of FIG. 3;

FIGS. 5A and 5B are enlarged views of the card case taken from the end view of FIG. 4C;

FIGS. 6A and 6B are plan and end views of an exemplary lock pick tool for retention in the exemplary card case of FIG. 3;

FIGS. 7A and 7B are plan and end views of an exemplary lock pick tool for retention in the exemplary card case of FIG. 3;

FIGS. 8A and 8B are plan and end views of an exemplary lock pick tool for retention in the exemplary card case of FIG. 3;

FIGS. 9A and 9B are plan and end views of an exemplary lock pick tool for retention in the exemplary card case of FIG. 3;

FIGS. 10A-10C are perspective and detailed views of an application of one of the exemplary lock pick tools shown in FIGS. 2 and 6-9;

FIGS. 11A and 11B are perspective and detailed views of an application of one of the exemplary lock pick tools shown in FIGS. 2 and 6-9;

FIGS. 12A and 12B are perspective and detailed views of an application of one of the exemplary lock pick tools shown in FIGS. 2 and 6-9;

FIGS. 13A and 13B are perspective and detailed views of an application of one of the exemplary lock pick tools shown in FIGS. 2 and 6-9; and

FIGS. 14A and 14B are perspective and detailed views of an application of one of the exemplary lock pick tools shown in FIGS. 2 and 6-9.

### DETAILED DESCRIPTION OF THE PREFERRED EMBODIMENTS

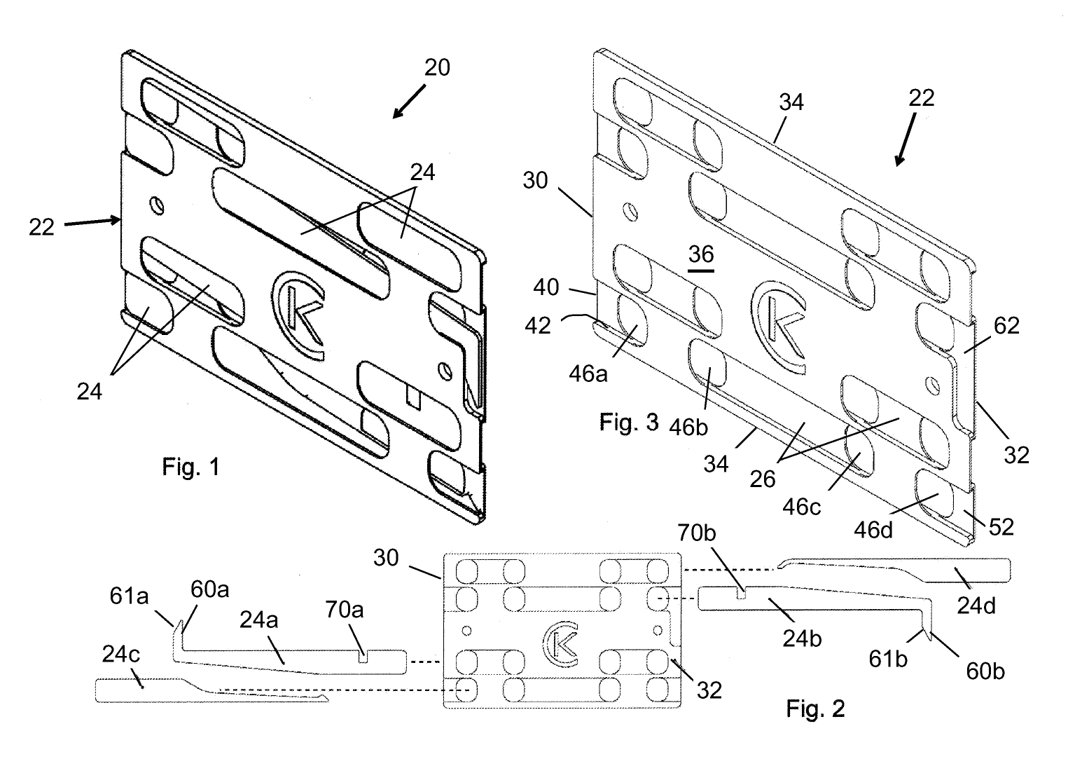

The present invention is directed to an improved slim tool set, in particular that can be easily carried in the wallet or in a shirt pocket. An exemplary tool set 20 having the exterior dimensions of an ordinary credit card and containing lock picking tools is seen in FIGS. 1-3, and will be described in more detail below. The tool set 20 includes a slim rounded rectangular card case 22 with receptacles for holding a plurality of tools 24 that can be easily extracted therefrom.

The illustrated card case 22 desirably has exterior dimensions no greater than an ordinary credit card. For the purpose of definition, an ordinary credit card shall be assumed to have dimensions of about: Length=3.370 in. (85.60 mm); Width=2.125 in. (53.98 mm); and thickness=0.05 in. (1.27 mm) including the embossed numbering. At the same time, cards must have rounded corners, with a radius of 3.18 millimeters. Indeed, these dimensions are even specified under international standards for the ID-1 format under ISO/IEC 7810:2003 and 7813. These ISO standards are commonly used for banking cards (ATM cards, credit cards, debit cards, etc.) or for driving licenses in many countries (including Australia, Brazil, Canada, European Union countries, New Zealand, Norway, and the United States). This format is also used as a personal identity card in many other countries, and for the United States passport card.

It should be understood, however, that although a credit card-sized tool set is particularly useful, the present invention should not be considered limited to such a size unless incorporated into a particular claim. Indeed, certain properties of the slim tool set described herein could be useful for larger tool sets, such as might fit within a standard school notebook. For example, one contemplated slim tool set having a card case with the length and width dimensions of ordinary notebook paper (i.e., 8.5×11 inches) could contain tools for drafting. Another possible slim tool set could be sized to fit within a day planner case having dimensions between ordinary notebook paper and a credit card. For example, such an intermediate-sized slim tool set could contain grooming tools, or ordinary workbench tools.

The exemplary card cases described herein can be made of a number of materials that can be generally described as rigid. For example, aluminum is believed particularly useful for its light weight and strength, though polymers like Delrin, Nylon or Polycarbonate may be used, the latter to achieve some level of transparency.

The individual tools within the card case are virtually unlimited in applications. The illustrated tools 24 are for picking locks, and should made out of some type of spring steel for its toughness and strength.

Now with reference to the illustrated embodiment, FIG. 1 shows the tool set 20 having the card case 22 and four lock picking tools 24, while FIG. 2 shows the tools 24 exploded from the card case 22. Each of the tools 24 has an elongated, flat and generally linear configuration that enables them to be slid into elongated slots 26 formed in the card case 22. FIG. 3 shows the card case 22 by itself such that the elongated slots 26 are more readily visible, and FIGS. 5A and 5B show them enlarged from an end view.

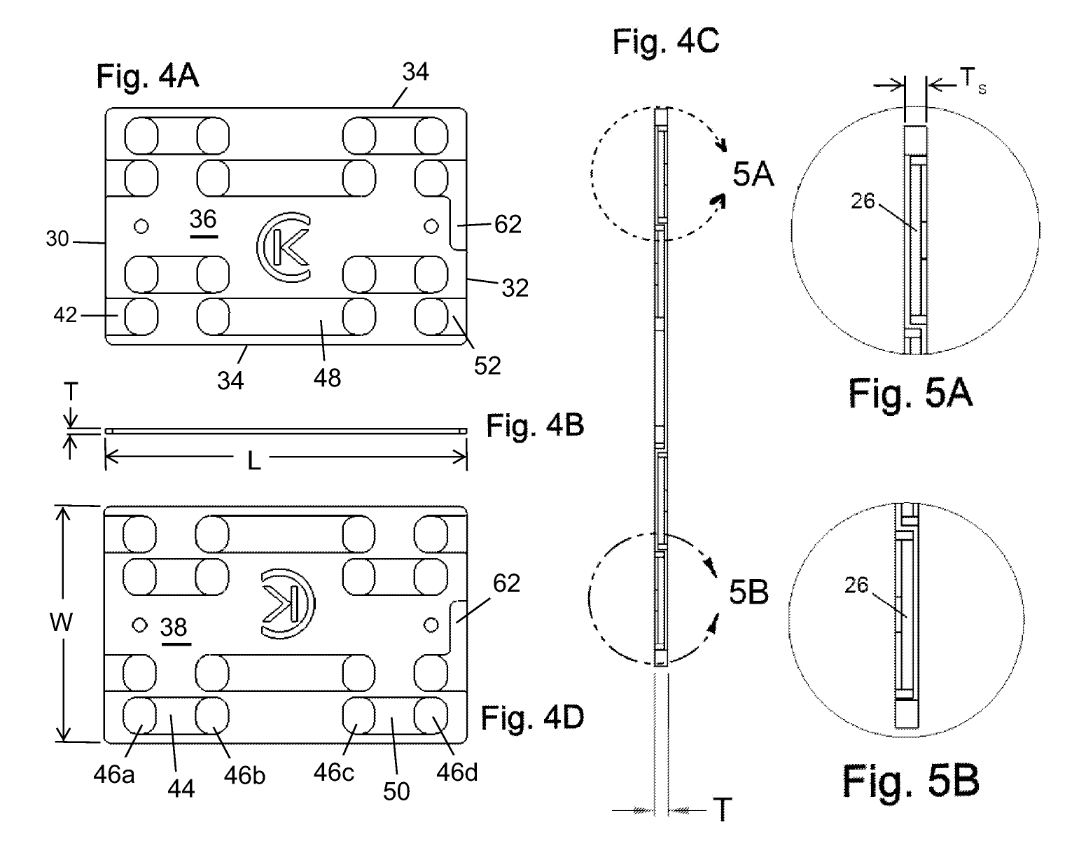

Prior to detailed description of the elongated slots 26, the orthogonal dimensions of the card case 22 includes a length L seen in FIG. 4B, a width W as seen in FIG. 4A, and a thickness T as also seen in FIGS. 4B and 4C. A number of exemplary dimensions are called out in the drawings corresponding to standard credit card dimensions, but those should not be considered limiting.

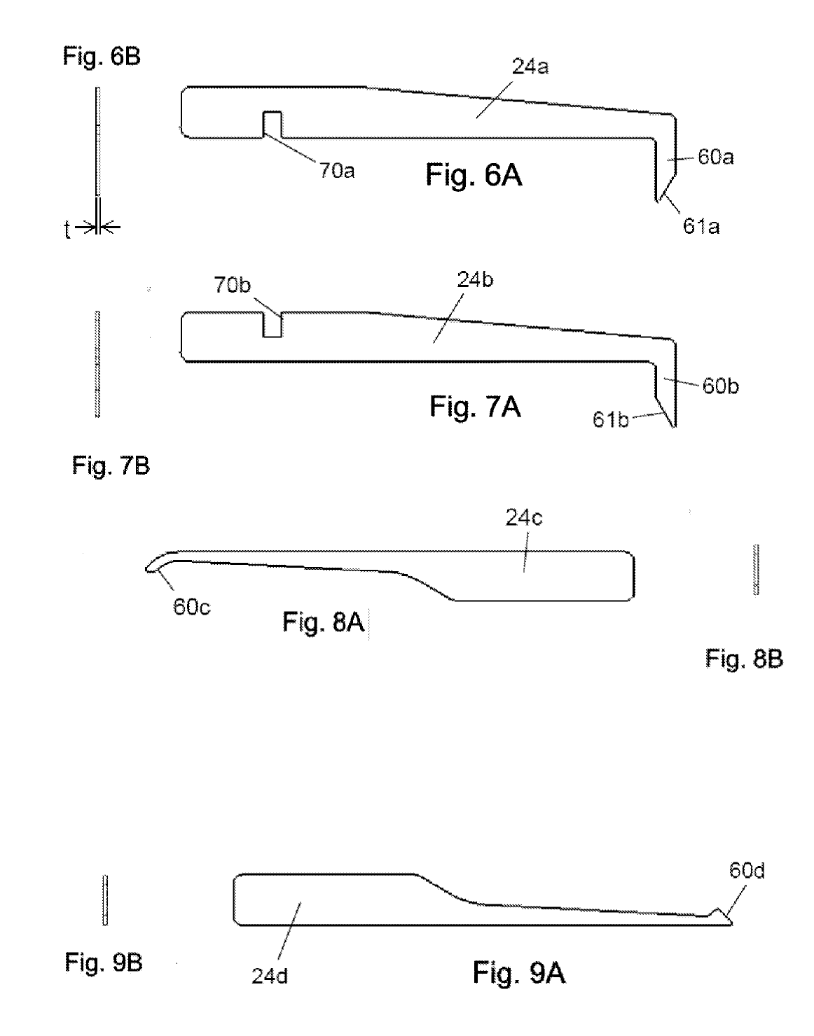

With reference back to FIG. 3, and to the detailed views of FIGS. 4-5, the rectangular card case 22 includes a first end edge 30, a second end edge 32, and two longer side edges 34 which in the illustrated embodiment are substantially identical. The card case 22 further includes a front face 36 and a rear face 38 (FIG. 4D). Each of the tools 24 slides into the slots 26 that open at one of the two end edges 30, 32. In the illustrated embodiment, as seen in FIG. 2, two of the tools 24a, 24b slide in through the first end edge 30, while the two other tools 24c, 24d slide in through the second end edge 32. As seen in the end views of FIGS. 6B, 7B, 8B and 9B, each of the tools 24 has an extremely slim profile with a uniform thickness denoted t. With reference to FIGS. 5A and 5B, the thickness dimension of each of the slots on the end edges 30, 32 of the card case 22 is denoted Ts, and is slightly smaller than the thickness t of the tools 24. There is thus a slight interference fit between the tools 24 and the elongated slots 26, which results in a slight friction fit that keeps the tools 24 from falling out of the card case 22. In an exemplary embodiment where the tool set 20 is sized the same as a standard credit card, the thickness t is about 0.025 inches, while the thickness Ts is about 0.024 inches.

With reference again to FIG. 3, and also to the orthogonal views in FIGS. 4-5, each of the slots 26 is formed in the card case 22 in an alternating pattern from the first end edge 30 to the second end edge 32. More particularly, each of the slots 26 is formed (e.g., machined) alternately in the front face 36 and the rear face 38 from the first end edge 30 to the second end edge 32. For example, the lowest slot 26 shown in FIG. 3 commences at an opening 40 in the first end edge 30 created by removal of material from the front face 36. The removed material removed creates a first recess 42, preferably rounded, that extends a short distance toward the second end edge 32, as seen in FIGS. 3 and 4A.

Before termination of the first front recess 42, a first rear recess 44 in the rear face 38 is provided, as seen in FIG. 4D. Overlap between the first front recess 42 and the first rear recess 44 creates a first through opening 46a over through the card case 22. This pattern continues with a second front recess 48 (FIG. 4A) which is somewhat longer than the other recesses, a second rear recess 50 (FIG. 4D), and a third front recess 52 that terminates at the second end edge 32. The elongated recess 48 in the middle of the card case 22 facilitates removal of each of the tools 24 by providing an elongated exposed portion of each tool which can be manipulated by hand. These recesses overlap to form additional through openings 46b, 46c, and 46d. The through openings 46 essentially connect the alternating patterns of recesses and open to the slots 26 that extend from the first end edge 30 to the second end edge 32. The material removed in the recesses 42, 44, 48, and 50 must be greater than one half of the total thickness T of the card case 22 to provide an overlap in removed material so as to form the longitudinal slots 26. For instance, if the total thickness T of the card case 22 is about 0.05 inches, then a thickness of the material removed in the recesses 42, 44, 48, and 50 may be about 0.037. Such an amount of material removed from opposite faces 36, 38 of the card case 22 creates an overlap of about 0.024 inches, as seen best in FIGS. 5A and 5B, which again is slightly smaller than the thickness of the exemplary tools 24.

It should be noted that the particular shape of each of the tools 24 may dictate slightly different configurations for each of the slots 26. For example, in the illustrated embodiment two of the lock picking tools 24a and 24b have bent ends 60a, 60b. The corresponding slots 26 feature end recesses 62 where material has been removed from one face 36, 38 as seen in FIGS. 4A and 4B that accommodate the bent ends 60.

FIGS. 6-9 illustrate exemplary lock picking tools 24 of the present application. FIGS. 6A-6B show a first lock pick tool 24a having an elongated body that gradually narrows from a handle end toward a functional end and terminates in a bent finger 60a having an outward facing bevel 61a. A second lock pick tool 24b shown in FIG. 7A also has an elongated body that gradually narrows from a handle end toward a functional and terminates in a bent finger 60b having an inward facing bevel 61b. Both of the fingers 60a, 60b are bent approximately 90° from the respective elongated body. Each of the lock pick tools 24a, 24b includes a generally rectangular cutout 70a, 70b, respectively. The cutouts 70a, 70b extend approximately half of the width of the tool and are located close to the end opposite from the end at which the bent fingers 60 are located. The cutout 70a on the first lock pick tool 24a opens in the direction of the associated bent finger 60a, while the cutout 70b on the second lock pick tool 24b opens opposite the direction of the associated bent finger 60b. When the cutouts 70a, 70b are engaged, the two lock pick tools 24a, 24b can be coupled together in the manner of tweezers, as will be explained below.

FIGS. 8A-8B illustrate a third lock pick tool 24c again having an elongated body that narrows from a handle end toward a functional end and terminates in a finger 60c which is gently curved to form a band of approximately 45° and is commonly called a hook pick. A fourth lock pick tool 24d shown in FIGS. 9A-9B again includes an elongated body that again narrows from a handle end toward a functional end and terminates in a small triangular-shaped tooth 60d commonly called a diamond pick. These supplementary lock pick tools 24c, 24d are the more commonly used lock picks known in the art.

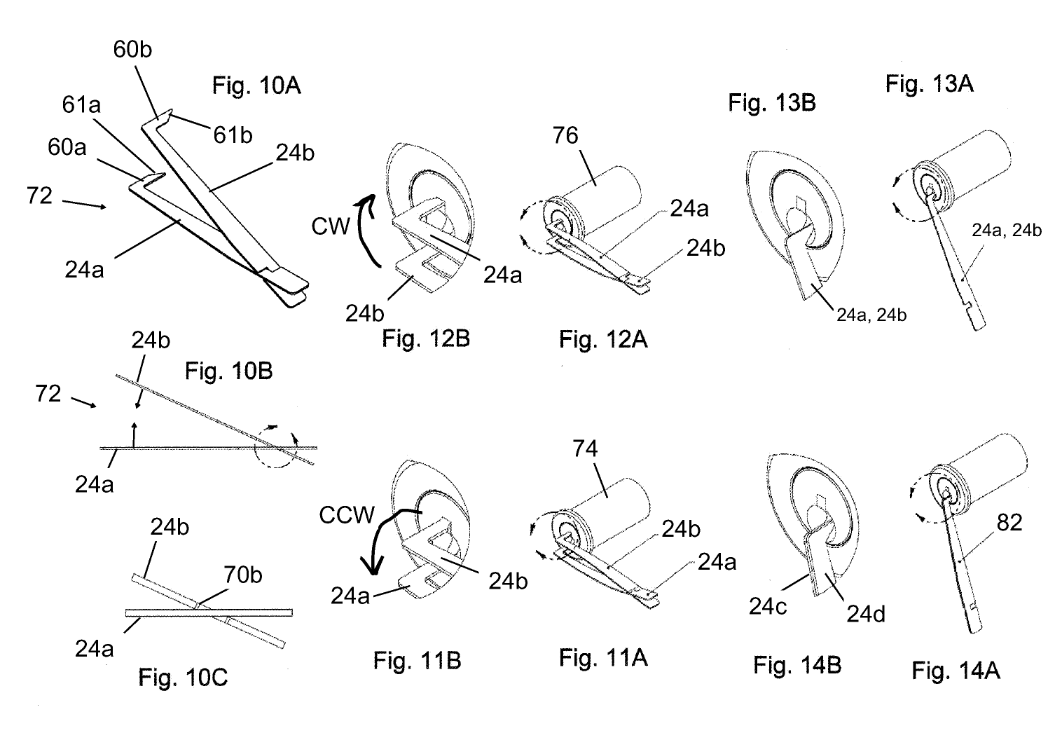

FIGS. 10-13 are various perspective views of applications of the exemplary lock pick tools shown in FIGS. 2 and 6-9. The first and second lock pick tools 24a and 24b can be used in various combinations to apply rotational tension to the keyway of a lock and are commonly called tension wrenches. Rectangular cutouts 70a and 70b on pick tools 24a and 24b engage each other to form a V-shaped tweezer-like assembly 72 shown in FIGS. 10 and 11. The separation of the bent ends 60 is intentionally greater than the keyway opening such that a small amount a spring force maintains separation of the bent ends 60 when inserted into the keyway opening of a lock. This provides unobstructed access to the keyway opening for the additional lock picking tools 24c and 24d. The oppositely-directed bevels 61a, 61b on the respective bents ends 60 provides the engagement necessary to apply clockwise tension to the lock cylinder 76 as shown in FIG. 12B or counter clockwise tension to the lock cylinder 74 as shown in FIG. 11B. Either orientation can be achieved by reversing the orientation of the rectangular features 70a, 70b shown in FIG. 10C.

Additional tension wrench combinations can be achieved by using one or both of pick tools 24a and or 24b, as shown in FIG. 13 or FIG. 14 respectively. That is, the pick tools 24a, 24b may be used alone, as seen in FIGS. 13A-13B, or in abutment with one another to form an assembly 82 as seen in FIGS. 14A-14B.

Although the invention has been described and illustrated with a certain degree of particularity, it is understood that the present disclosure has been made only by way of example, and that numerous changes in the combination and arrangement of parts can be resorted to by those skilled in the art without departing from the scope of the invention, as hereinafter claimed.

What is claimed is:

1. A slim tool set, comprising:
a card case having a length, a width, and a thickness, the card case being substantially planar and defining a first end edge, a second end edge, two side edges, a front face, and a rear face, the card case further having a plurality of slots that extend the length of the card case from the first end edge to the second end edge, each of the slots being formed by alternately removing material from the front face and the rear face to form a series of recesses on the opposite faces that overlap and define through holes through the card case, each of the slots having a thickness dimension; and
a plurality of slim tools retained within the outer dimensions of the card case and within the slots, each of the tools having a thickness dimension slightly larger than the thickness dimension of the respective slot.

2. A credit card-sized slim lock pick tool set, comprising:
a card case having a length, a width, and a thickness of the size of a standard credit card including embossed numbering, with the thickness being no greater than about 0.05 in. (1.27 mm), the card case being substantially planar and defining a first end edge, a second end edge, two side edges, a front face, and a rear face, the card case further having a plurality of slots that extend the length of the card case from the first end edge to the second end edge, each of the slots opening to one of the end edges and at least one slot opening to each of the end edges; and
a plurality of slim lock pick tools retained within the outer dimensions of the card case and within the slots, wherein at least two of the lock pick tools may be coupled together in at least two different configurations to form tweezer-like tension wrenches.

3. A credit card-sized slim lock pick tool set, comprising:
a card case having a length, a width, and a thickness of the size of a standard credit card including embossed numbering, with the thickness being no greater than about 0.05 in. (1.27 mm), the card case being substantially planar and defining a first end edge, a second end edge, two side edges, a front face, and a rear face, the card case further having a plurality of slots that extend the length of the card case from the first end edge to the second end edge, each of the slots opening to one of the end edges and at least one slot opening to each of the end edges, each of the slots being formed by removing material from the front face and the rear face to form a series of recesses on the opposite faces that overlap and define through holes through the card case, wherein a middle recesses for each slot is longer than the other recesses; and
a plurality of slim lock pick tools retained within the outer dimensions of the card case and within the slots, wherein each of the lock pick tools is exposed by the middle recess of the respective slot and can be slid in one direction along the slot in the card case to be removed from one of the end edges.
